(19) United States
(12) Patent Application Publication
(10) Pub. No.: US 2023/0017213 A1
(43) Pub. Date: Jan. 19, 2023

(54) Blackout Curtain

(71) Applicant: Mahalo Eco Blinds Pty Ltd., Currumbin Waters (AU)

(72) Inventor: Aliesha Shorten, Currumbin Waters (AU)

(21) Appl. No.: 17/868,490

(22) Filed: Jul. 19, 2022

Related U.S. Application Data
(60) Provisional application No. 63/223,202, filed on Jul. 19, 2021.

(51) Int. Cl. A47H 23/08; A47H 1/18; C08J 5/18; C08L 67/04

(52) U.S. Cl. CPC A47H 23/08; A47H 1/18; C08J 5/18; C08L 67/04; C08J 2367/04; C08J 2467/02; C08J 2403/02; C08L 2201/06; C08L 2205/025; C08L 2205/03

(57) ABSTRACT

A blackout curtain includes a sheet body having a blackout side and a face side that together extend to a perimeter. A fastener is provided for mounting the sheet body to or adjacent a window frame. The sheet body is constructed of a biodegradable and compostable material.

### CROSS-REFERENCE TO RELATED APPLICATIONS

This application for a utility patent claims the benefit of U.S. Provisional Application No. 63/223,202, filed Jul. 19, 2021.

### BACKGROUND OF THE INVENTION

### Field of the Invention

This invention relates generally to blackout curtains, and more particularly to a blackout curtain that is biodegradable and compostable.

### Description of Related Art

More traditional blackout curtains are constructed of linen. While these provide the benefits of all natural and sustainable materials, they require multiple layers of black foam and other materials to make them opaque enough to provide a sufficient barrier to light.

More modern blackout curtains are constructed of a single layer of plastic, vinyl, polyester, and other artificial materials. While blackout curtains made of artificial materials do not require multiple layers to be added, these curtains are not biodegradable, compostable, or sustainable. There is therefore a long-felt need for a blackout curtain that has a thin, simple single layer construction, but is fully biodegradable and compostable. To date, this need has not yet been met; however, the present invention fulfills these needs and provides further advantages as described in the following summary.

### SUMMARY OF THE INVENTION

The present invention teaches certain benefits in construction and use which give rise to the objectives described below.

The present invention provides a blackout curtain for mounting to a window frame. The blackout curtain comprises a sheet body having a blackout side and a face side that together extend to a perimeter; a means for attachment for mounting the sheet body to or adjacent the window frame; and wherein the sheet body is constructed of a biodegradable and compostable material.

A primary objective of the present invention is to provide a blackout curtain having advantages not taught by the prior art.

Another objective is to provide a blackout curtain that is constructed of a biodegradable and compostable.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a blackout curtain according to one embodiment of the present invention, illustrating the blackout curtain mounted on or adjacent a window frame.

### DETAILED DESCRIPTION OF THE INVENTION

The above-described drawing figures illustrate the invention, a blackout curtain 10 for completely covering a window. As discussed in greater detail below, the blackout curtain 10 is constructed of a biodegradable and compostable composition.

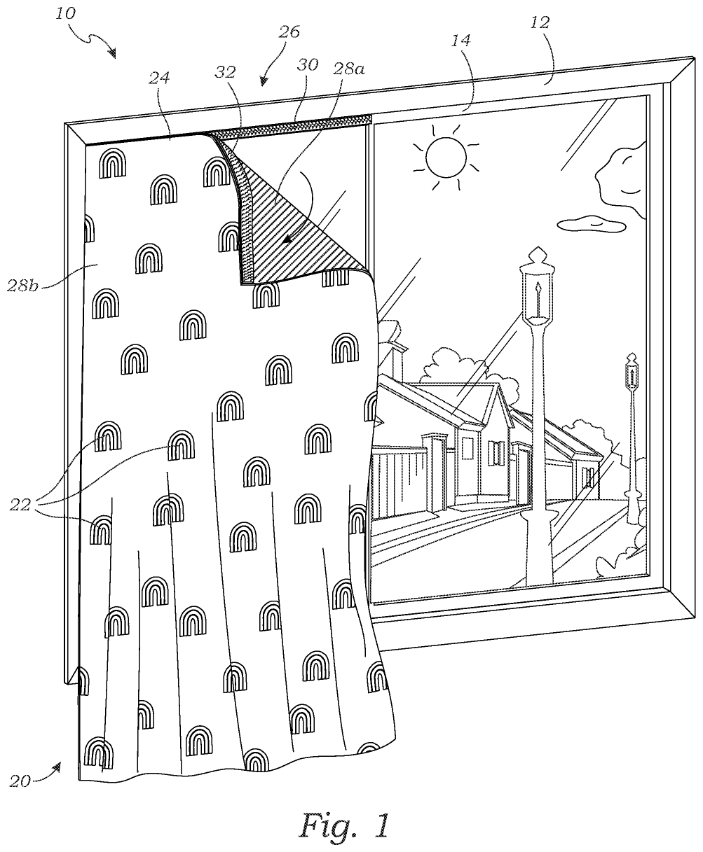

FIG. 1 is a perspective view of a blackout curtain 10 according to one embodiment of the present invention, illustrating the blackout curtain 10 mounted on or adjacent a window frame 12. As shown in FIG. 1, the blackout curtain 10 comprises a sheet body 20 having a blackout side 28a and a face side 28b which extends to a perimeter 24.

The sheet body 20 of the blackout curtain 10 is constructed of a biodegradable and compostable material that is adapted to block light. As shown in FIG. 1, the blackout curtain 10 may include a pattern/design 22 on at least a portion of the curtain 10. In this embodiment, the sheet body 20 is approximately 1.2×2 m, but in other embodiments may be any suitable size for covering any clear panes (i.e., window, door, etc.) or light sources, which may be a wide variety of sizes and proportions, as is well known in the art. Furthermore, in some embodiments, the sheet body 20 may have a thickness between approximately 0.05-0.20 mm, preferably between 0.10-0.15 mm, in this embodiment approximately 0.13 mm.

As previously mentioned, the sheet body 20 is composed of a biodegradable and compostable material. In some embodiments, the biodegradable material is in the form of a compostable polymer made from bioplastics and starch (e.g., cornstarch). In this embodiment, the bioplastic is in the form of polylactic acid (PLA) and polybutylene adipate terephthalate (PBAT), both biodegradable and non-toxic. The bioplastic may have the added benefit of having no chemical smell, unlike many plastic polymers that form fabric sheets. Alternatively, the bioplastic may be a different combination of biodegradable materials (e.g., including various cellulose compositions or similar).

In this embodiment, the bioplastics are mixed with cornstarch to form the fabric sheet body 20. In the current embodiment, the body 20 is constructed of a composition that includes approximately 75% of a combination of PLA and PBAT, and approximately 25% starch. All percentages are measured by weight.

However, in other embodiments, similar starches or organic/biodegradable materials may be used. In on example, tapioca or other underground starch may be incorporated for finishing or sizing purposes during the composition process, i.e., boiling/cooking starch into the fabric sheet. Starch finishing and sizing compositions may be utilized for sizing the bioplastic threads preparatory to weaving them into cloth, and for sizing cloth in finishing processes after the cloth has been bleached, dyed or otherwise finished. In some embodiments, the starch is liquefied and gelatinized, or it may be only gelatinized, or use any other suitable process for including starch in a fabric composition. Furthermore, additional materials may be used during the composition process, e.g., an amylolytic or liquefying enzyme, or any other similar materials used the art. In some applications of the present invention, other materials may be combined with the bioplastic and starch composition, e.g., cotton, rayon, etc. or any other biodegradable material that may be woven or otherwise formed with the bioplastic.

As shown in FIG. 1, the sheet body 20 has the blackout side 28a and the face side 28b, wherein the face side 28b may include the pattern 22. The pattern 22 may be printed, dyed, stamped, etc. onto the face side 28b, using any suitable method known to those skilled in the art. Alternatively, the face side 28b may not include a pattern 22. In such an embodiment, the face side 28b may be a different color or texture than the blackout side 28a, or they may be the same color/texture. As shown in the drawing, in this embodiment, the pattern 22 on the face side 28b is in the form of a plurality of rainbows printed on the sheet body 20, but in other embodiments, the pattern 22 may be any desirable pattern, including any symbols/text/graphics, or color blocking, or any other patterns or designs capable of being printed or otherwise added to the face side 28b. Furthermore, in some embodiments, the blackout side 28a may also include a pattern or graphic (not shown).

In this embodiment, the blackout side 28a is an opaque color, e.g., black, or any other desired color(s), that significantly blocks out light (i.e., absorbs/reflects light). For the purposes of this application, the term “significantly” is defined to mean that the sheet body 20 is capable of blocking enough of the light that the interior of the structure is rendered dark that is at least comparable to nighttime conditions.

The sheet body 20 of the blackout curtain 10 includes a means for attachment 26 to the window frame 12. As discussed above, the blackout curtain 10 may be attached to any structure through which light passes, and the window 12 shown in FIG. 1 is included only for the purpose of example. In this embodiment, the means for attachment 26 is in the form of a fasteners such as a hook and loop fastener, wherein a first strip of material 30 having hooks or loops is mounted (e.g., pinned, glued, etc.) to an upper portion 14 of the window frame 12, and a second strip of material 32 having loops or hooks, respectively, is mounted to the upper edge 24 of the blackout side 28a of the blackout curtain 10. The strips 30 and 32 may be selectively connected together to open or close the blackout curtain 10, and may further enable ease of installment of the blackout curtain 10, while being lightweight for ease of organization and transport. However, in alternative applications of the present invention, the means for attachment 26 may be any other usable means, e.g., standard curtain 10 rod loops/conduits, clamps/pins, etc. or any other means of attachment 26 known in the art.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A blackout curtain for mounting to a window frame, the blackout curtain comprising:
a sheet body having a blackout side and a face side that together extend to a perimeter;
a means for attachment for mounting the sheet body to or adjacent the window frame; and
wherein the sheet body is constructed of a biodegradable and compostable material.

2. The blackout curtain of claim 1, wherein the sheet body is constructed of a composition that is at least 50% by weight polylactic acid (PLA) made from the sugars in corn starch, cassava or sugarcane, and polybutyrate adipate terephthalate (PBAT).

3. The blackout curtain of claim 1, wherein the sheet body is constructed of a composition comprising:
about 75% by weight polylactic acid (PLA) and polybutyrate adipate terephthalate (PBAT); and
about 25% starch.

4. The blackout curtain of claim 3 wherein the sheet body is between 0.10-0.15 mm in thickness.

5. The blackout curtain of claim 1, wherein the means for attachment includes a fastener mounted on at least some of the perimeter of the sheet body.

6. The blackout curtain of claim 1, wherein the means for attachment includes a hooks and loops fastener mounted on at least some of the perimeter of the sheet body, and wherein the hooks and loops fasteners are mounted directly to the window frame.
